(19) United States
(12) Patent Application Publication
(10) Pub. No.: US 2013/0050220 A1
(43) Pub. Date: Feb. 28, 2013

(54) METHOD AND APPARATUS FOR MANAGING SCHEDULES IN A PORTABLE TERMINAL

(71) Applicants: Tae Yeon KIM, Seoul (KR); Mi Jung PARK, Gyeonggi-do (KR)

(72) Inventors: Tae Yeon KIM, Seoul (KR); Mi Jung PARK, Gyeonggi-do (KR)

(73) Assignee: SAMSUNG ELECTRONICS CO., LTD., Gyeonggi-do (KR)

(21) Appl. No.: 13/596,383

(22) Filed: Aug. 28, 2012

(30) Foreign Application Priority Data
Aug. 31, 2011 (KR) 10-2011-0087966

(51) Int. Cl. G06T 11/20

(52) U.S. Cl. 345/440

(57) ABSTRACT

A method manages schedules in a portable terminal. The method includes: searching for at least one schedule corresponding to a preset search condition when requesting a schedule search in the portable terminal; and displaying the searched at least one schedule in a two-dimensional form having a time axis and a schedule axis according to the time sequence in case there is at least one schedule as a result of the search.

### CLAIM OF PRIORITY

This application claims, pursuant to 35 USC 119(a), priority from, and the benefit of the earlier filing date of a patent application filed in the Korean Intellectual Property Office on Aug. 31, 2011 and afforded Serial Number 10-2011-0087966, the contents of which are incorporated by reference herein.

### BACKGROUND OF THE INVENTION

1. Field of the Invention

The present invention relates to a method and apparatus for managing a schedule, and more particularly, to a method and apparatus for managing a schedule in a portable terminal capable of performing an integrated search for all schedules registered in an event, a task and a memo, etc. and indicating at least one searched schedule according to a time sequence.

2. Description of the Related Art

Recently, with rapid development of information communication technologies and semiconductor technologies, portable terminals are being widely used. As such, a portable terminal has become a necessity for many people. The portable terminal provides various functions including a TV viewing function (e.g., mobile broadcasting such as digital multimedia broadcasting and digital video broadcasting), a music replay function (e.g., an MP3 function), a photographing function, a data communication function, an Internet connection function and a near field communication (NFC) function, etc. as well as a general communication function. In particular, portable terminals provide a schedule management function.

The schedule management applications and functions of the portable terminal can generally register one's schedule in the form of a task, an event and a memo, etc. Further, the schedule management application provides a schedule search function which can search for the preregistered schedule. However, schedule management applications in the prior art provide only a function of simply listing and outputting the searched schedule in the form of a list. Likewise, portable terminals in the prior art have a problem in that users cannot easily recognize the schedule according to a time sequence because the searched result is displayed only in the form of a list. In addition, portable terminals in the prior art can search for a schedule registered in only one of a task, an event and a memo. That is, the schedule management applications in the prior art cannot integrally search for a schedule which is registered in different forms (a task, an event or a memo).

### SUMMARY OF THE INVENTION

The present invention has been made in view of addressing and solving the above problems, and provides a method and apparatus for managing a schedule in a portable terminal capable of displaying a searched result according to a time sequence when searching for a schedule.

The present invention further provides a method and apparatus for managing a schedule in a portable terminal capable of integrally searching all schedules registered in an event, a task and a memo, etc. and displaying the searched result when searching for a schedule.

The present invention further provides a method and apparatus for managing a schedule in a portable terminal capable of searching schedules registered in a server that provides a schedule management function as well as schedules registered in the portable terminal and displaying the searched result when searching for a schedule.

In accordance with an aspect of the present invention, a method for managing schedules in a portable terminal includes: searching for at least one schedule corresponding to a preset search condition when requesting a schedule search in the portable terminal; and displaying the searched at least one schedule in a two-dimensional form having a time axis and a schedule axis according to a time sequence in case there is at least one schedule as a result of the search.

In accordance with another aspect of the present invention, an apparatus for managing schedules in a portable terminal includes: a controller that controls a search for at least one schedule corresponding to a preset search condition when requesting a schedule search in the portable terminal, and displays the searched at least one schedule in a two-dimensional form having a time axis and a schedule axis according to a time sequence in case there is at least one schedule corresponding to the search condition as a result of the search; and a display unit that displays at least one searched schedule on a two-dimensional graph under control of the controller.

### BRIEF DESCRIPTION OF THE DRAWINGS

The above features and advantages of the present invention will be more apparent from the following detailed description in conjunction with the accompanying drawings, in which:

FIG. 1 is a schematic diagram illustrating a portable terminal and a server according to an exemplary embodiment of the present invention;

FIG. 2 is a flowchart illustrating a method for managing a schedule in the portable terminal according to the exemplary embodiment of the present invention;

FIG. 3 is a series of exemplary screens progressively illustrating the setting of search conditions according to the exemplary embodiment of the present invention; and

FIG. 4 is a set of exemplary screens illustrating changes in a search result screen according to the exemplary embodiment of the present invention.

### DETAILED DESCRIPTION OF THE INVENTION

Preferred embodiments of the present invention are described herein below with reference to the accompanying drawings in detail. This invention may, however, be embodied in many different forms and should not be construed as limited to the exemplary embodiments set forth herein. The same reference numbers are used throughout the drawings to refer to the same or like parts. Detailed descriptions of well-known functions and structures incorporated herein may be omitted to avoid obscuring the subject matter of the present invention. Also, terms described herein, which are defined considering the functions of the present invention, may be implemented differently depending on user and operator's intention and practice. Therefore, the terms should be understood on the basis of the disclosure throughout the specification. The principles and features of this invention may be employed in varied and numerous embodiments without departing from the scope of the invention.

Furthermore, although the drawings represent exemplary embodiments of the invention, the drawings are not necessarily to scale and certain features may be exaggerated or omitted in order to more clearly illustrate and explain the present invention.

Among the terms set forth herein, a terminal refers to any kind of device capable of processing data which is transmitted or received to or from any external entity. The terminal may display icons or menus on a screen to which stored data and various executable functions are assigned or mapped. The terminal may include a computer, a notebook, a tablet PC, a mobile device, and the like.

Among the terms set forth herein, a screen refers to a display or other output devices which visually display information to the user, and which optionally are capable of receiving and electronically processing tactile inputs from a user using a stylo, a finger of the user, or other techniques for conveying a user selection from the user to the output devices.

Among the terms set forth herein, an icon refers to a graphical element such as a figure or a symbol displayed on the screen of the device such that a user can easily select a desired function or data. In particular, each icon has a mapping relation with any function being executable in the device or with any data stored in the device and is used for processing functions or selecting data in the device. When a user selects one of the displayed icons, the device identifies a particular function or data associated with the selected icon. Then the device executes the identified function or displays the identified data.

Among terms set forth herein, data refers to any kind of information processed by the device, including text and/or images received from any external entities, messages transmitted or received, and information created when a specific function is executed by the device.

A portable terminal according to an exemplary embodiment of the present invention is an electronic device having a schedule management function, and can include a mobile communication terminal, a personal digital assistant (PDA), a smart phone, a tablet PC, and a portable multimedia player (PMP), etc.

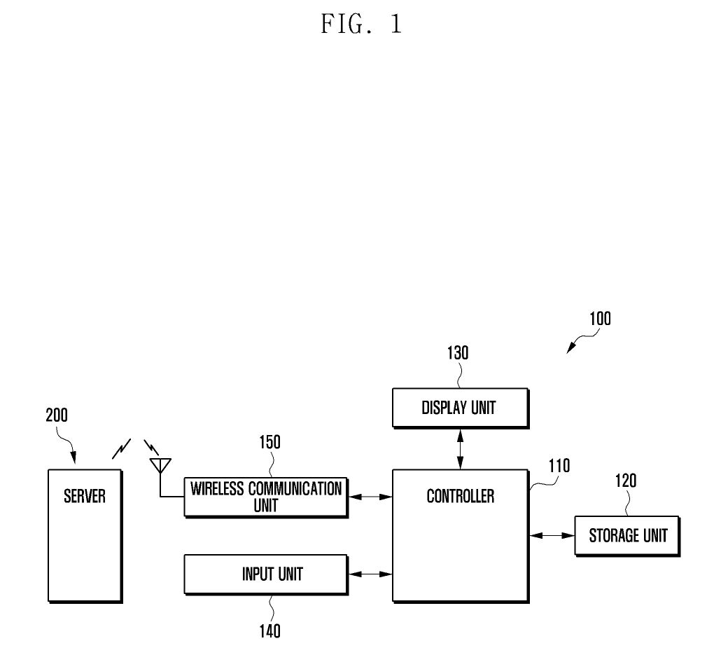

FIG. 1 is a schematic diagram illustrating the portable terminal and a server according to the exemplary embodiment of the present invention.

Referring to FIG. 1, the server 200 is a computing device that provides a schedule management function, and can be a web server or a cloud server, etc. The server 200 according to the exemplary embodiment of the present invention can receive and store at least one schedule from the portable terminal 100. For example, the server 200 may synchronize the schedule with the portable terminal 100. The server 200 receives a schedule search request and a search condition which is inputted or set by a user from the portable terminal 100. The server 200 searches at least one schedule corresponding to the search condition and transmits the searched at least one schedule to the portable terminal 100.

The portable terminal 100 according to the exemplary embodiment of the present invention can include a wireless communication unit 150, an input unit 140, a display unit 130, a storage unit 120 and a controller 110.

The wireless communication unit 150 can form a communication channel for a call (which may include a voice call and/or a video call) with a base station, and a data communication channel for data transmission. To this end, the wireless communication unit 150 can include a wireless frequency transmission unit (not shown) which frequency-up-converts and amplifies a transmitted signal, a wireless frequency receiving unit (not shown) which low-noise-amplifies and frequency-down-converts a received signal, and a transmission and reception separation unit (not shown) which separates a received signal from a transmitted signal, etc., in a manner known and implemented in the art. In particular, for a schedule management application which supports a schedule synchronization function, the wireless communication unit 150 according to the exemplary embodiment of the present invention can transmit the schedule of the portable terminal 100 to a server 200 or can receive the schedule from the server 200. When requesting a schedule search, the wireless communication unit 150 transmits a search condition which is inputted or set by a user to the server 200, and can receive at least one schedule corresponding to the search condition from the server 200. In an exemplary embodiment, the server 200 is a computing device that provides a schedule management function, and can be a web server or a cloud server, etc.

The input unit 140 can include input keys and function keys for receiving an input of numbers or various sets of letter information, for setting various functions and controlling the functions of the portable terminal 100. In particular, the input unit 140 according to the exemplary embodiment of the present invention can transmit, to the controller 110, a signal that requests execution of a schedule search mode, and can transmit a signal that requests a search of the schedule registered in the portable terminal 100 according to a preset search condition, etc. Such an input unit 140 can be implemented by one of or a combination of input means such as a button-type key pad, a ball joystick, an optical joystick, a wheel key, a touch pad and a touch screen, etc.

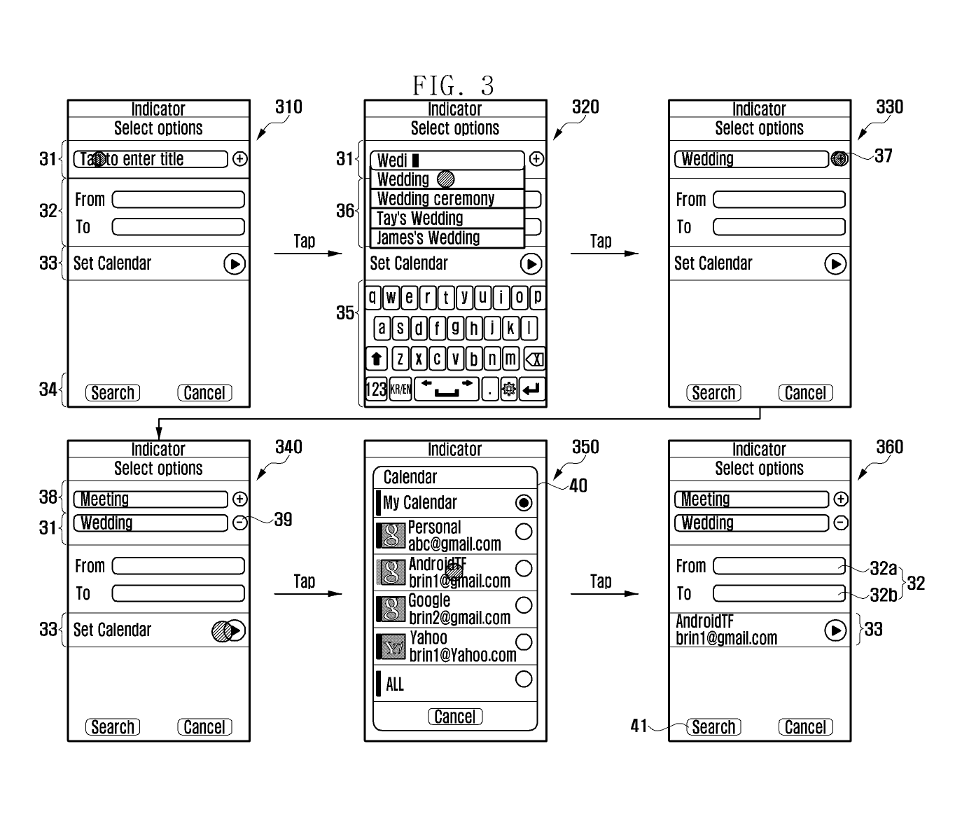

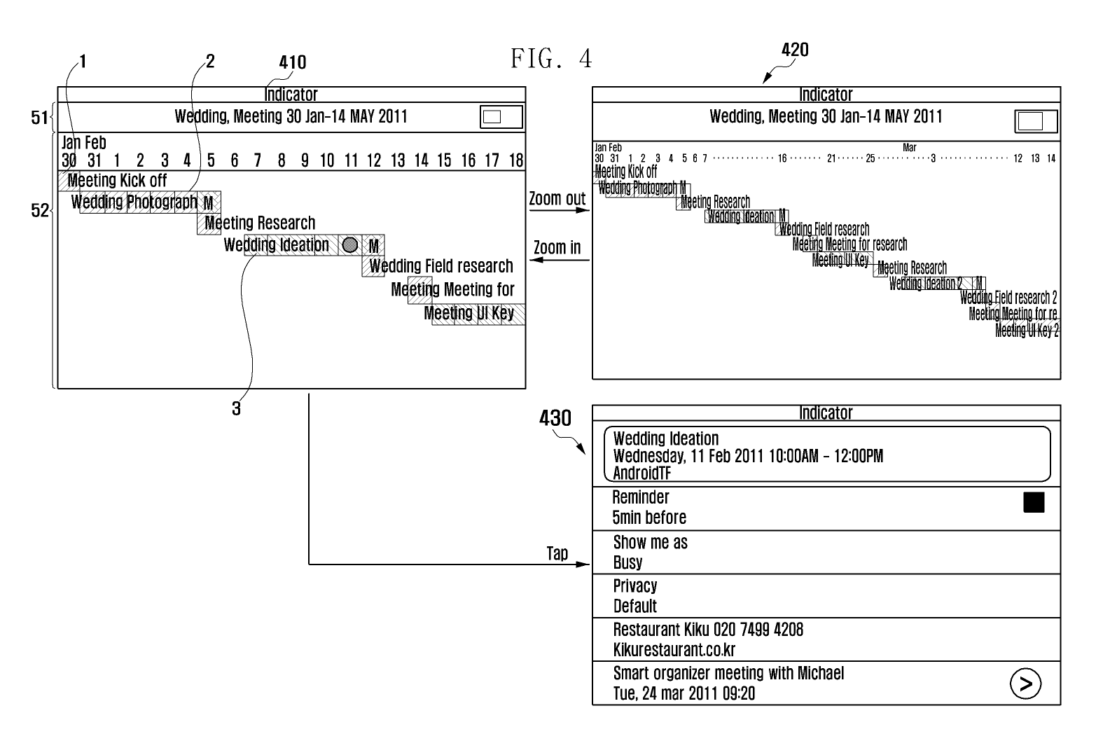

The display unit 130 displays information inputted by the user or information provided to the user as well as various menus of the portable terminal 100. That is, the display unit 130 can provide various screens according to the use of the portable terminal 100 such as an idle screen, a menu screen, a message writing screen and a calling screen, etc. In particular, the display unit 130 of the present invention displays a search condition setting screen which can set a search condition for searching for the schedule when executing a schedule search mode, and displays a search result screen according to the search condition when the schedule search is requested. Further, the display unit 130 can output a detailed information screen of a schedule selected from a search result screen. The searched schedule is displayed on the search result screen in a two-dimensional form having a time axis and a schedule axis according to a time sequence. For example, the display unit 130 displays a two-dimensional graph having the time axis as a horizontal axis and the schedule axis as a vertical axis under control of the controller 110, and can separately display each of the searched schedules in different lines which can be lengthwise divided. The display unit 130 will be explained in greater detail later with reference to example screens shown in FIGS. 3 and 4. The display unit 130 can be implemented using a liquid crystal display (LCD), an organic light emitted diode (OLED), an active matrix organic emitted diode (AMOLED), etc. Further, if the display unit 130 is implemented as or includes a touch screen, the display unit 130 can perform a function of the input unit 140, and/or may operate with or may incorporate the input unit 140. The display unit 130 in conjunction with the input unit 140 may provide a graphic user interface (GUI) for allowing the user to access the portable terminal 100 and to perform various functions, as described herein.

The storage unit 120 can store user data and data transmitted and received during communications, etc. as well as an application program which is necessary for other optional functions such as a sound replay function, an image or video replay function, and a broadcast replay function, etc. The storage unit 120 can store at least one schedule management application. The schedule management application can register a schedule in the form of an event, a task and a memo, etc. In particular, the storage unit 120 according to the present invention can store a schedule search program. The schedule search program can search a schedule corresponding to a search condition inputted by the user (e.g., a keyword, a search period, and an E-mail account, listed as an E-mail address, etc.) among schedules registered in the schedule management application of the portable terminal 100, and can display the search result in a two-dimensional form according to a time sequence. Further, the schedule search program can search for a schedule registered in the server 200 that provides a schedule management function. To this end, the schedule search program can transmit a search condition inputted by the user to the server 200 through the wireless communication unit 150, and can receive the search result from the server 200 through the wireless communication unit 150.

The controller 110 can control general operation of the portable terminal 100 and a signal flow between internal blocks of the portable terminal 100, and perform a data processing function that processes data. In particular, if a schedule search mode is executed, the controller 110 according to the present invention can control the display unit 130 to output, to the display unit 130, a search condition setting screen which can allow a user, using the input unit 140, to set a search condition for the schedule search. The search condition setting screen can include, for receiving user inputs by the user using the input unit 140, a keyword input area where at least one keyword can be inputted, a period setting area where a search period for a schedule search can be set, and an account selection area where an account for a schedule search can be selected. For example, the account may be E-mail account. Each E-mail account is associated with a user or groups of users, such as teams, who use schedules, and such E-mail accounts are listed by their E-mail address stored in a database accessible and/or stored by the server 200, which can be accessed and searched by the schedule management application. The E-mail account and E-mail address may be the destination at which a schedule is E-mailed for providing notifications and reminders to users of events, such as meetings. In an exemplary embodiment, the E-mail account is a schedule management application which provides E-mail notifications to users of scheduled events and appointments.

The controller 110 can check whether there is at least one schedule corresponding to a search condition inputted through the search condition setting screen in the portable terminal 100 or the server 200 in case a schedule search is requested. That is, the controller 110 can check whether there is a schedule corresponding to the search condition in a task, event or memo which has been preregistered in at least one schedule management application included in the portable terminal 100. In case there is a schedule corresponding to the search condition in the portable terminal 100, the controller 110 can display at least one searched schedule in a two-dimensional form on the display unit 130 according to a time sequence. Further, the controller 110 can transmit the search condition to the server 200 that provides a schedule management function, can receive the search result from the server 200, and can then display at least one received schedule according to the time sequence. For example, the controller 110 can control the display unit 130 to display a searched schedule based on a time line specified by a time sequence. Further, when displaying the searched schedule, the controller 110 can display names of each schedule together with keywords related with each schedule on a search result screen. Further, the controller 110 can check whether there is a schedule to which a memo is linked or attached or otherwise associated with among the searched one or more schedules, and can display an icon on the display unit 130, which informs the user of the fact that there is such a schedule, with the icon being displayed at one end of the displayed schedule.

Further, in case a certain schedule is selected in a search result screen displaying the searched schedule, the controller 110 can control the display unit 130 to output detailed information of a selected certain schedule. Further, the controller 110 can enlarge/reduce the search result screen according to a zoom in/out signal generated in response to user selections entered into the input unit 140 or a touch screen (not shown).

It is understood that the portable terminal 100 can also optionally include components having additional functions such as a near field communication (NFC) module for near field communication, a broadcast receiving module for broadcast reception, a digital sound source replay module such as an MP3 module, and an Internet communication module for performing an Internet-accessing function, etc. Not all such additional and/or optional components are listed herein because they can be modified in various ways according to the design choice of the manufacturer and/or the convergence trend of digital devices, but the portable terminal 100 according to the present invention can further include any or all of such known components including, but not limited to, the above mentioned components.

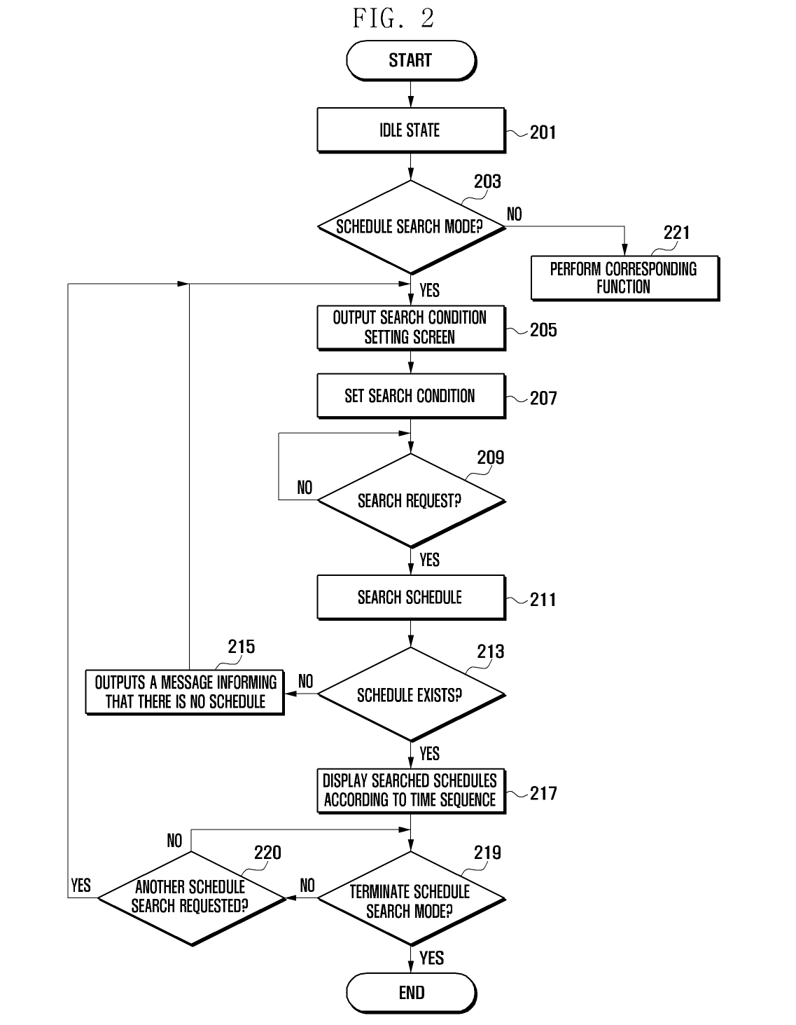

FIG. 2 is a flowchart illustrating a method for managing a schedule in the portable terminal according to the exemplary embodiment of the present invention.

Referring to FIGS. 1 and 2, the controller 110 according to the exemplary embodiment of the present invention can be in an idle state in step 201. Thereafter, the controller 110 can check whether a schedule search mode is executed or selected by the user in step 203. The schedule search mode can be executed when the user inputs a preset function key and/or a soft key through the input unit 140. Further, the schedule search mode can be executed through a menu or a shortcut menu displayed on the display unit 130.

If the schedule search mode is not executed, the controller 110 can perform a corresponding function in step 221, with a corresponding function being a function selected by the user, with a corresponding operation performed by the portal terminal 100. For example, the controller 110 can perform a schedule registration function, a deleting function and a modifying function, etc. or can perform a music play function and a broadcast receiving function, etc. according to the user's request. Further, the controller 110 can maintain an idle state by returning to step 201 after completing step 221. However, if the schedule search mode is detected to be executed in step 203, the controller 110 can output a search condition setting screen on the display unit 130 in step 205, which is viewed by the user and which may prompt the user to use the input unit 140 to enter user selections which can set a search condition for a schedule search. The search condition setting screen can include a keyword input area where a keyword can be inputted, a period setting area where a search period can be set, and/or an account selection area where an E-mail account for a search can be selected. The account can be an E-mail account accessible by a schedule management application included in the portable terminal 100 or in the server 200. Thereafter, the user can set a search condition related with a schedule intended to be searched in step 207. The search condition setting will be described in greater detail herein with reference to FIG. 3.

The controller 110 can then check whether a search request is inputted in step 209. That is, the controller 110 can check whether a search menu is inputted. In case the search request is not inputted, the controller 110 can loop back and continue to perform step 209 to check for an inputted search request. Otherwise, if the search request is inputted in step 209, the controller 110 can search for a schedule included in the portable terminal 100 based on the search condition in step 211. In performing step 211, it is preferable that the controller 110 searches all tasks, events and memos preregistered in the schedule management application, and confirms whether there is at least one schedule corresponding to the search condition.

If the schedule search is completed, the controller 110 can check whether there is at least one schedule corresponding to the search condition in step 213. As a result, in case there is no schedule corresponding to or satisfying the search condition, the controller 110 can control outputting a message, for example, a visual message on the display unit 130, which informs the user that there is no such schedule in step 215. Alternatively or in addition to the visual message, an audio message such as a predetermined noise or a prerecorded voice message, stored in the storage unit 120, can be output to the user through a speaker of the portable terminal 100, indicating that there is no such schedule corresponding to or satisfying the input or set search condition. Thereafter, if a preset time (e.g., 2 seconds) passes, the controller 110 can return to step 205. At this time, the controller 110 can control the display unit 130 for outputting the search condition setting screen to the display unit 130 in the state where the preset search condition is inputted, or removing the previously inputted condition, and instead outputting the search condition setting screen in the initial state for display by the display unit 130.

Further, in case there is a schedule corresponding to the search condition, which is found in step 213, the controller 110 can display the searched schedule in a two-dimensional form having a time axis and a schedule axis according to the time sequence in step 217. At this time, the controller 110 can display the searched schedule based on the time line, which will be described in greater detail with reference to FIG. 4.

Next, the controller 110 checks whether a schedule search mode termination signal has been inputted in step 219. In case the schedule search mode termination signal is inputted, the controller 110 can terminate the schedule search mode and return to the idle mode. On the other hand, in case the schedule search mode termination signal is not inputted, the controller 110 checks whether another schedule search is requested in step 220. In case another schedule search is not requested, the controller loops back to step 219. On the other hand, in case another schedule search request is requested, the controller 110 returns to step 205 and repeats the above-described process. For example, in case a command to move to the previous step is inputted (e.g., a cancelation key, such as icons labeled Cancel and displayed on the example screens in FIG. 3), the controller 110 can return to step 205 and output the search condition setting screen. At this time, the user can perform a new search for a schedule by changing the search condition through the search condition setting screen.

Further, in an alternative exemplary embodiment, in the event that no schedule exists at step 213, the controller 110 can control the display unit 130 to output a blank time line screen which does not display a schedule in step 215 instead of outputting the message to the user. In a further alternative exemplary embodiment, the message output on the display unit 130, or otherwise conveyed to the user at step 215, may instead be outputted for a certain period of time, and the process returns to step 205, but the controller 110 can control the display unit 130 to maintain the outputting of the message until a command to remove the message is inputted by the user using the input unit 140.

In additional alternative exemplary embodiments, when a certain schedule is selected among the searched schedules displayed in step 217, the controller 110 can also output a detailed information screen of the selected schedule on the display unit 130. Further, the controller 110 can enlarge/reduce the search result screen in response to a zoom out/in command entered by the user using the input unit 140. The explanation of such a zoom out/in command will be described in greater detail herein with reference to FIG. 4.

Further, in an exemplary embodiment, only a schedule registered in the portable terminal 100 is searched, but the present invention is not limited to this example. For example, the controller 110 transmits the search condition to a server 200 (e.g., a web server and/or a cloud server, etc.) that provides a schedule management function, and in case there is at least one schedule corresponding to the search condition in the server 200, the controller 110 can receive at least one schedule corresponding to the search condition from the server 200. In addition, in case that the schedule management function is set to search for a schedule registered in the server 200, the present invention can search for not only an individual schedule, but also for a team schedule which is operated and shared in team units, such as team members or others including in a group, and thus the schedule can be more efficiently managed.

Hereinafter, the present invention will be explained in more detail through the exemplary embodiments of screens in FIG. 3. Further, it is assumed that the display unit 130 implements a touch screen for the convenience of explanation.

FIG. 3 is a series of exemplary screens progressively illustrating the setting of search conditions according to the exemplary embodiment of the present invention. As indicated, each screen is accessed by a user tapping an icon or section of the screens 310-360 to initiate an action, with such tapping occurring after the user inputs user selections and/or data.

Referring to FIG. 3, if a search condition setting mode is executed, the display unit 130 can display a search condition setting screen in the example screen 310. The search condition setting screen 310 can include a keyword input area 31 for inputting a keyword, a period setting area 32 for setting a time period for searching for a schedule, an account selection area 33 for selecting an account for searching for a schedule, and a menu area 34. Each account may be an E-mail account associated with a user or groups of users, such as teams, who use schedules, and such E-mail accounts are stored in a database accessible to and/or stored by the server 200, which can be accessed and searched by the schedule management application.

As shown in FIG. 3, the schedule management application is set in the account selection area 33 to a default application which sets a calendar for a default account, such as a calendar function of an E-mail service used by the E-mail account associated with the user of the portable terminal 100.

In the search condition setting screen 310, if the user touches a keyword input area 31, the display unit 130 can output a virtual keypad 35 as illustrated in the example screen 320. The user can input a keyword related to a schedule intended to be searched using the virtual keypad 35. Further, if a keyword is inputted by the user, the controller 110 can extract expected candidate keywords 36, which may also include keyword phrases such as “Wedding ceremony”, based on the inputted keyword, and display the extracted candidate keywords 36 on the lower part of the keyword input area 31 in screen 320, for example, in a pull-down menu which appears on the screen 320 showing the candidate keywords 36. The candidate keywords 36 can be extracted from among titles or names of schedules preregistered in the portable terminal 100. In addition, keyword search and matching methods known in the art may be used to find the candidate keywords 36 from among the titles, and can auto-complete such candidate keywords 36, in a manner known in the art. For example, when a user enters “Wed”, various candidates such as “James's Wedding” may be obtained, with the entered search phrase “Wed” being matched with the partial phrase “Wed” within the complete phrase “James's Wedding”. Accordingly, keyword extraction is not limited to searching for words and symbols only at the beginning of titles of schedules, but can find matching candidates in a manner known in the art.

In the state as shown in the screen 320, if any one of the candidate keywords 36, such as the “wedding” keyword, is selected by the user, the controller 110 can input the selected candidate keyword “wedding” in the keyword input area 31 as illustrated in the example screen 330. Further, as illustrated in the example screen 340, by touching the keyword addition menu 37, which includes an icon showing a plus sign in a circle in screen 330, the user can add a new keyword input area 38, and add a pew keyword “meeting” in screen 340. At this time, the controller 110 can change the keyword addition menu 37 of the previous keyword input area 31 to be a deletion menu 39, illustrated as an icon with a minus sign in a circle.

Next, in case the user touches an account selection area 33 in screen 340, the display unit 130 can output a list 40 of an account which exists in the portable terminal 130 as illustrated in the example screen 350. The list 40 includes the default calendar labeled “My Calendar” associated with the user associated with the portable terminal 100, as well as E-mail addresses of the user. If at least one account for a schedule search is selected from the list 40, the display unit 130 can remove the list 40 and display information on the selected account in the account selection area 33 as illustrated in the example screen 360.

Further, the user can set a period of time for searching for a schedule through the period setting area 32 in screen 360. According to the period setting method, the user can touch a start date input area 32a or a termination date input area 32b, and then directly input a date through a virtual keypad, or output a calendar when touching the start date input area 32a or the termination date input area 32b, select a desired date from the calendar and set the search period.

After the setting of the search condition is completed through the above explained method, if a search menu is touched, the controller 110 can control the display unit 130 to perform a schedule search, based on the preset search condition, by pressing the Search icon 41 shown in screens 310 and 330-360, and output the search result in a two-dimensional form according to a time sequence. At this time, in case a condition for the search period and the account is not set, the controller 110 can search for a schedule for the entire period and for all known accounts. Alternatively, the user can press the Cancel icons shown in screens 310 and 330-360 to cancel a current action or to clear the current screen from the display unit 130.

FIG. 4 is a set of exemplary screens illustrating changes in a schedule search result screen according to the exemplary embodiment of the present invention.

Referring to FIG. 4, the display unit 130 can output a search result screen as shown in the example screen 410 if the schedule search is completed. That is, the controller 110 can display the searched schedule in the form of a time line. In detail, the controller 110 can control the display unit 130 to display the searched schedule in a two-dimensional form having a time axis and a schedule axis according to a time sequence. In FIG. 4, the exemplary embodiment displaying the searched schedule on a two-dimensional graph having the time axis as a horizontal axis and the schedule axis as a vertical axis is illustrated. However, the present invention is not limited to the embodiment. That is, in another embodiment of the present invention, the searched schedule on a two-dimensional graph having the time axis as a vertical axis and the schedule axis as a horizontal axis, can be displayed.

Further, the search result screen can include a search condition display area 51 for displaying a keyword and a search period, and a schedule display area 52 for displaying at least one searched schedule. A screen position display window 43, which indicates the position of the visible screen currently being outputted on the display unit 140, can be displayed, for example, at the right end of the search condition display area 51.

The controller 110 can display a keyword and a search period inputted by the user on the search condition display area 51. That is, referring to the example screen, it can be understood that the user searched for a schedule using the search conditions of keywords “wedding” and “meeting” and the search period “Jan. 30, 2011 to May 14, 2011”, as displayed in the search condition display area 51 in the screen 410 under the label “Indicator”. Further, the controller 110 can indicate an icon or display field indicating the searched E-mail account in the search condition display area 51.

The controller 110 can display each schedule in the form of a bar graph when displaying a searched schedule. At this time, the horizontal length of the bar graph represents the period of the schedule. Referring to the example screen 410, the first schedule 1 uses a one day period of January 30, the second schedule 2 uses the period of 6 days from January 31 to February 5, and the third schedule 3 uses the period of 7 days from February 7 to February 13.

The controller 110 can separately display each of the searched schedules in different lines which can be lengthwise divided (in case that the schedule axis is the vertical axis). Further, the controller 110 can display the title or name of each schedule and the keyword related with each schedule together when displaying the searched result. For example, referring to the example screen 410, it can be understood that the name of the first schedule 1 is “kick off” and the related keyword is “meeting”, the name of the second schedule 2 is “photograph” and the related keyword is “wedding”, and the name of the third schedule 3 is “ideation” and the related keyword is “wedding”, with such keywords show in the areas occupied by the horizontal bars representing the corresponding schedules. Accordingly, in the present invention, by displaying the name and keyword of the schedule together, a user can easily recognize each schedule and the related keywords even in case a schedule is searched by a multiple of keywords.

Further, when displaying the search result, the controller 110 can check whether there is a schedule linked to a memo among searched schedules, and in case there is a schedule linked to a memo, the controller 110 can display an icon that informs that there is a linked (or attached) memo at one end of the schedule. For example, M-shaped icons can be displayed at the right end of the bar graph as shown in the second schedule 2 and the third schedule 3 of the example screen 410. However, the present invention is not limited to displaying M-shaped icons. Clicking or tapping the memo icon may retrieve the attached memo, which may be a team roster, a meeting agenda, or any other additional information associated with the displayed schedule.

Further, the search result screen can zoomed in/out. For example, in the state as shown in the example screen 410, if a zoom out command (e.g., a pinch after a multi-touch action) is inputted in the touch screen associated with the display unit 130 and the input unit 140, the controller 110 can output a new screen on the display unit 130 by reducing the search result screen 410 to appear as illustrated in the example screen 420, through which the user can easily recognize the entire schedule at a glance. Alternatively, in the state as shown in the example screen 420, if a zoom in command (e.g., a scratch after a multi-touch action) is inputted in the touch screen associated with the display unit 130 and the input unit 140, the controller 110 can extend and output the search result screen as illustrated in the example screen 410.

As shown in screens 410, 420 of FIG. 4, the screen position display window 43 changes the representation of the displayed schedules which were zoomed in or zoomed out, providing the user with a visual indication of the search results which may be viewed and accessible by further scrolling of the graphic user interface (GUI) provided on the display unit 130.

As a result of the search, if a certain schedule is selected, for example, by being touched on the display unit 130, by the user from among schedules displayed in the screen, the controller 110 can output detailed information of the selected schedule. For example, if a third schedule 3 is touched in the example screen 410, for example, by a tapping operation, the controller 110 can output detailed information of the third schedule 3 as illustrated in the example screen 430 in FIG. 4. Further, the detailed description may be outputted in the entire screen 430, or alternatively, the detailed information can be displayed in the form of a pop-up window, such that the screen 430 covers or overlaps portions of the screen 410.

According to a method and apparatus for managing a schedule in a portable terminal 100 according to the exemplary embodiment of the present invention, when searching for a schedule, the searched schedule is displayed according to the time sequence, and thus the user can easily recognize the entire schedule. In addition, according to the present invention, because all schedules registered in an event, a task and a memo, etc. of a schedule management application of a portable terminal 100 are integrally searched and the searched result is displayed according to the time sequence, the user can easily recognize the related schedule and can systematically manage the entire schedule. In addition, according to the present invention, when searching for a schedule, any schedule registered in a server 200, which provides a schedule management function, can be searched, and thus the search function can be performed for team schedules shared among teammates, or group schedules for groups of people, as well as an individual schedule, and the shared team schedule can also be easily searched.

The above-described apparatus and methods according to the present invention can be implemented in hardware, firmware or as software or computer code that can be stored in a recording medium such as a CD ROM, a RAM, a ROM, a floppy disk, DVDs, a hard disk, a magnetic storage media, an optical recording media, or a magneto-optical disk and/or as a floptical disk, or computer code downloaded over a network originally stored on a remote recording medium, a computer readable recording medium, or a non-transitory machine readable medium and to be stored on a local recording medium, so that the methods described herein can be rendered in such software that is stored on the recording medium using a general purpose computer, a digital computer, or a special processor or in programmable or dedicated hardware, such as an ASIC or FPGA. Further, the program command may include a machine language code created by a complier and a high-level language code executable by a computer using an interpreter. The foregoing hardware device may be configured to be operated as at least one software module to perform an operation of the present invention. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

The above described present invention can search all schedules stored in the portable terminal in the form of an event, a task and a memo, when searching for a schedule, and display the searched schedule in the form of time-line, so that a user can easily recognize the related schedule. Accordingly, a user can easily perform schedule management.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A method for managing schedules in a portable terminal, the method comprising:
searching for at least one schedule corresponding to a preset search condition in response to a schedule search input in the portable terminal; and
displaying the searched at least one schedule in a two-dimensional form having a time axis and a schedule axis according to a time sequence.

2. The method of claim 1, wherein displaying in the two-dimensional form according to the time sequence comprises:
displaying the searched at least one schedule on a two-dimensional graph having the time axis as a horizontal axis and the schedule axis as a vertical axis; and
separately outputting each of the searched at least one schedule in different lines which are lengthwise divided.

3. The method of claim 1, further comprising:
outputting a search condition setting screen including a keyword input area where at least one keyword is inputted, a period setting area where a search period is set, and an account selection area where an account for a schedule search is selected when executing a schedule search mode for the schedule search; and
setting the search condition through the search condition setting screen.

4. The method of claim 3, wherein setting the search condition further comprises:
extracting a candidate keyword from a plurality of names of preregistered schedules based on the at least one keyword inputted in the keyword input area, and displaying the extracted candidate keyword.

5. The method of claim 1, wherein displaying in the two-dimensional form according to the time sequence displays a name associated with each schedule together with a keyword associated with each schedule.

6. The method of claim 1, wherein displaying in the two-dimensional form according to the time sequence comprises:
checking whether a first schedule of the searched at least one schedule is linked to a memo; and
displaying an icon, representing the linked memo, at one end of a graphically representation of the first schedule.

7. The method of claim 1, further comprising:
outputting detailed information of a selected schedule in response to a selection of one of the searched at least one schedule.

8. The method of claim 1, further comprising:
enlarging or reducing a screen displaying the searched at least one schedule, according to a signal input corresponding to one of a zoom in selection or a zoom out selection.

9. The method of claim 1, wherein searching for at least one schedule corresponding to the search condition comprises at least one of:
searching tasks, events and memos registered with a schedule management application of the portable terminal; and
transmitting the search condition to a server that provides a schedule management function, and receiving the searched at least one schedule corresponding to the search condition from a plurality of schedules registered in the server.

10. An apparatus for managing schedules in a portable terminal, the apparatus comprising:
a controller that controls searching for at least one schedule corresponding to a preset search condition in response to a schedule search input in the portable terminal, and displaying the searched at least one schedule in a two-dimensional form having a time axis and a schedule axis according to a time sequence; and
a display unit that displays the searched at least one schedule in the two-dimensional form under control of the controller.

11. The apparatus of claim 10, wherein the controller controls the display unit to display the searched at least one schedule on a two-dimensional graph having the time axis as a horizontal axis and the schedule axis as a vertical axis and separately display each of the searched at least one schedule in different lines which are lengthwise divided.

12. The apparatus of claim 10, wherein the display unit displays a search condition setting screen including a keyword input area where at least one keyword is inputted, a period setting area where a search period is set, and an account selection area where an account for a schedule search is selected when executing a schedule search mode for the schedule search.

13. The apparatus of claim 12, wherein, in response to the at least one keyword being inputted in the keyword input area, the controller extracts a title based on the inputted at least one keyword from a plurality of names of preregistered schedules, and displays the extracted title as a candidate keyword.

14. The apparatus of claim 10, wherein the controller displays a name associated with each schedule and a keyword associated with each schedule when displaying the searched at least one schedule.

15. The apparatus of claim 10, wherein the controller checks whether a first schedule of the searched at least one schedule is linked to a memo, and displays an icon, representing the linked memo, at one end of a graphical representation of the first schedule.

16. The apparatus of claim 10, wherein the controller controls the display unit to display detailed information of a selected schedule in response to a selection of one of the searched at least one schedule.

17. The apparatus of claim 10, wherein the controller enlarges or reduces a screen displaying the searched at least one schedule, according to a signal input corresponding to one of a zoom in selection or a zoom out selection.

18. The apparatus of claim 10, wherein the controller searches tasks, events and memos registered with a schedule management application of the portable terminal in response to the input as a request for a search of the at least one schedule corresponding to the preset search condition.

19. The apparatus of claim 10, further comprising:
a wireless communication unit that transmits the search condition to a server that provides a schedule management function, and receives the searched at least one schedule corresponding to the search condition from the server in response to the input as a request for a search of the at least one schedule corresponding to the preset search condition under control of the controller.

20. The apparatus of claim 12, wherein the controller sets the search condition in response to the at least one keyword inputted through the search condition setting screen.
